(19) United States
(12) Patent Application Publication
(10) Pub. No.: US 2013/0215910 A1
(43) Pub. Date: Aug. 22, 2013

(54) TRANSMISSION APPARATUS, TRANSMISSION METHOD, PROGRAM, AND COMMUNICATION SYSTEM

(71) Applicant: Sony Corporation, (US)

(72) Inventor: Naoki Inomata, Kanagawa (JP)

(73) Assignee: Sony Corporation, Tokyo (JP)

(21) Appl. No.: 13/767,239

(22) Filed: Feb. 14, 2013

(30) Foreign Application Priority Data
Feb. 21, 2012 (JP) 2012-034652

(51) Int. Cl. H04L 7/00

(52) U.S. Cl. CPC H04L 7/0008
USPC 370/503

(57) ABSTRACT

A transmission apparatus transmits a timestamp in increments of 10^{-Y} seconds in accordance with a standard. The transmission apparatus includes a first counter counting a clock value based on a reference clock of α×10^{X} Hz to output values in increments of 10^{Y-X} at intervals of α for α consecutive times, a second counter counting the clock value based on the reference clock so as to output α values 0 through α−1 repeatedly, a table in which the α values output from the second counter are associated individually with evenly dispersed values each smaller than the 10^{Y-X}, a conversion portion converting the output from the second counter to values each smaller than the 10^{Y-X} by referring to the table, and an addition portion adding up the output from the first counter and the output from the conversion portion so as to generate the timestamp in increments of the 10^{-Y} seconds.

### BACKGROUND

The present disclosure relates to a transmission apparatus, a transmission method, a program, and a communication system. More particularly, the disclosure relates to a transmission apparatus, a transmission method, a program, and a communication system suitable for synchronizing time information with a master device with high accuracy, the master device being connected via a network.

There already exist schemes for synchronizing the internal time information between devices connected via a network. A representative one of such schemes is IEEE 1588 PTP (Precision Time Protocol; see Japanese Patent Laid-Open No. 2010-190635).

According to IEEE 1588 PTP, PTP messages are communicated between a master device (called the PTP master hereunder) and a slave device (called the PTP slave hereunder) connected via a network so as to synchronize the time information of the PTP slave with that of the PTP master. Specifically, an oscillating frequency f1 in the PTP master is synchronized with an oscillating frequency f2 in the PTP slave, before the time information of the PTP master is synchronized with that of the PTP slave.

In the ensuing description, the act of synchronizing the oscillating frequency f1 in the PTP master with the oscillating frequency f2 in the PTP slave will be referred to as frequency synchronization, and the act of synchronizing the time information of the PTP master with that of the PTP slave will be called time synchronization.

FIG. 1 shows an outline of a related-art high-precision time synchronization process that uses IEEE 1588 PTP.

The PTP master transmits onto the network a Sync message serving as a PTP message including a transmission time T1ᵢ as time information (timestamp) of the PTP master, in a predetermined cycle Lm based on the oscillating frequency f1. Upon receipt of the Sync message from the PTP master, the PTP slave extracts the transmission time T1ᵢ from the message and reads a reception time T2ᵢ as time information (timestamp) of the PTP slave. That is, every time a Sync packet is received, the PTP slave acquires the transmission time T1ᵢ (timestamp of the PTP master) and reception time T2ᵢ (timestamp of the PTP slave).

Also, the PTP slave transmits a PTP message “Delay_req” to the PTP master via the network so as to read a transmission time T3 as the time information (timestamp) of the PTP slave. Upon receipt of the PTP message “Delay_req,” the PTP master reads a reception time T4 as the time information (timestamp) of the PTP master, and returns a PTP message “Delay_res” including the reception time T4 to the PTP slave. That is, the PTP slave receives the response “Delay_res” with regard to the transmitted PTP message “Delay_req,” thereby acquiring the transmission time T3 (timestamp of the PTP slave) of the message “Delay_req” and the reception time T4 of the PTP master (timestamp of the PTP master).

It is assumed here that the time required to communicate PTP messages such as the Sync message, Delay_req and Delay_res over the network remains constant (called the network delay time hereunder).

On that assumption, if the oscillating frequency f1 of the PTP master is equal to the oscillating frequency f2 of the PTP slave, then the cycle of Sync message transmission by the PTP master (Δm=T1₂−T1₁) should coincide with the cycle of Sync message reception by the PTP slave (Δs=T2₂−T2₁). In other words, if the difference between Δm and Δs (Δm−Δs) is not zero, that means an asynchronous state in which there exists an error between the oscillating frequency f1 of the PTP master and the oscillating frequency f2 of the PTP slave.

Thus with regard to frequency synchronization, the oscillating frequency f2 of the PTP slave may be adjusted so as to bring the difference between Δm and Δs (Δm−Δs; called frequency drift hereunder) to zero. The frequency drift Δm−Δs is calculated using the following expression (1):

Frequency drift Δm−Δs=(T1₂−T1₁)−(T2₂−T2₁)=(T2₁−T1₁)−(T2₂−T1₂) (1)

With regard to time synchronization, the PTP slave may calculate the time difference defined by the expression (4) below based on the Sync message transmission time T1₂, Sync message reception time T2₂, Delay_req transmission time T3, and Delay_req reception time T4. The PTP slave may then have its internal clock T2 adjusted so that the time difference will become zero.

Network delay of Sync message=(T2₂−time difference)−T1₂=(T2₂−T1₂)−time difference (2)

Network delay of Delay_req=T4−(T3−time difference)=(T4−T3)+time difference (3)

Since it is assumed that the network delay of the Sync message coincides with the network delay of the Delay_req message and that the network delay remains constant, the time difference is defined by the expression (4) below resulting from the subtraction of the expression (3) from the expression (2) above:

Time difference={(T2₂−T1₂)−(T4−T3)}/2 (4)

Also, the network delay is calculated using the expression (5) below resulting from the addition of the expressions (2) and (3) above:

Network delay={(T2₂−T1₂)+(T4−T3)}/2 (5)

### SUMMARY

In the case of AV (audiovisual)-related electronic equipment that may serve as the PTP master or PTP slave, the reference clock is most preferably set to the frequency of 27 MHz that is suitable for processing video data. Where the clock value to be counted up in keeping with the reference clock of 27 MHz is used as time information, the structure for obtaining the time information may be simplified with no need to set up a PLL (Phase Locked Loop) or the like separately.

Meanwhile, IEEE 1588 PTP stipulates that the PTP master and PTP slave communicate time information (timestamp) with one another in increments of 10⁻⁹ seconds (ns: nanoseconds).

Thus when transmitting the time information (timestamp) to the PTP slave, the PTP master needs to convert the clock value of 27 MHz to a timestamp in nanoseconds. Upon receipt of the timestamp, the PTP slave needs to convert in reverse the timestamp in nanoseconds to the clock value of 27 MHz.

A single count of 27 MHz is 37.037037037037 . . . (=10⁹/27×10⁶) ns, which is a recurring decimal. In the past, the recurring decimal was rounded at a predetermined decimal place when the reference clock value of 27 MHz was converted to nanoseconds.

However, the timestamp in nanoseconds rounded at a given decimal place necessarily contains an error. That means the time information of the PTP slave and that of the PTP master may not be synchronized with high precision therebetween.

The present disclosure has been made in view of the above circumstances and provides arrangements for letting a master device and a slave device communicate timestamps without error therebetween.

According to one embodiment of the present disclosure, there is provided a transmission apparatus for transmitting a timestamp in increments of 10^{-Y} seconds in accordance with a standard. The transmission apparatus including:

a first counter configured to count a clock value based on a reference clock of α×10^{X} Hz so as to output values in increments of 10^{Y-X} at intervals of α for α consecutive times;

a second counter configured to count the clock value based on the reference clock so as to output α values 0 through α−1 repeatedly;

a table in which the α values output from the second counter are associated individually with evenly dispersed values each smaller than the 10^{Y-X};

a conversion portion configured to convert the output from the second counter to values each smaller than the 10^{Y-X} by referring to the table, and

an addition portion configured to add up the output from the first counter and the output from the conversion portion so as to generate the timestamp in increments of the 10^{-Y} seconds.

Preferably, the standard may be IEEE 1588 PTP, and the increments of 10^{-Y} may be increments of 10⁻⁹.

Preferably, the α×10^{X} Hz may be 27×10⁶ Hz.

Preferably, the transmission apparatus of this embodiment may further include a clock block configured to generate the clock value by counting up in accordance with the reference clock of the α×10^{X} Hz.

According to another embodiment of the present disclosure, there is provided a transmission method for use with a transmission apparatus for transmitting a timestamp in increments of 10^{-Y} seconds in accordance with a standard. The transmission method includes:

counting a clock value based on a reference clock of α×10^{X} Hz so as to output values in increments of 10^{Y-X} at intervals of α for α consecutive times;

counting the clock value based on the reference clock so as to output α values 0 through α−1 repeatedly;

in reference to a table in which the repeatedly output α values are associated individually with evenly dispersed values each smaller than the 10^{Y-X}, converting the output α values to values each smaller than the 10^{Y-X}, and

adding up the values output in increments of 10^{Y-X} at intervals of α and the values resulting from the conversion so as to generate the timestamp in increments of the 10^{-Y} seconds.

According to a further embodiment of the present disclosure, there is provided a program for use with a computer for transmitting a timestamp in increments of 10^{-Y} seconds in accordance with a standard. The program causing the computer to function as an apparatus includes:

a first counter configured to count a clock value based on a reference clock of α×10^{X} Hz so as to output values in increments of 10^{Y-X} at intervals of α for α consecutive times;

a second counter configured to count the clock value based on the reference clock so as to output α values 0 through α−1 repeatedly;

a table in which the α values output from the second counter are associated individually with evenly dispersed values each smaller than the 10^{Y-X};

a conversion portion configured to convert the output from the second counter to values each smaller than the 10^{Y-X} by referring to the table, and

an addition portion configured to add up the output from the first counter and the output from the conversion portion so as to generate the timestamp in increments of the 10^{-Y} seconds.

According to the above-outlined embodiments of the present disclosure, a clock value is counted based on a reference clock of α×10^{X} Hz so as to output values in increments of 10^{Y-X} at intervals of α for α consecutive times. The clock value above is counted based on the reference clock so as to output α values 0 through α−1 repeatedly. In reference to a table in which the repeatedly output α values are associated individually with evenly dispersed values each smaller than 10^{Y-X}, the output α values are converted to values each smaller than 10^{Y-X}. Then, the values output in increments of 10^{Y-X} at intervals of α and the values resulting from the conversion are added up to generate the timestamp in increments of 10^{-Y} seconds.

According to an even further embodiment of the present disclosure, there is provided a communication system including a transmission apparatus and a reception apparatus. The transmission apparatus communicates with the reception apparatus a timestamp in increments of 10^{-Y} seconds in accordance with a standard. The transmission apparatus includes:

a first counter configured to count a clock value based on a reference clock of α×10^{X} Hz so as to output values in increments of 10^{Y-X} at intervals of α for α consecutive times;

a second counter configured to count the clock value based on the reference clock so as to output α values 0 through α−1 repeatedly;

a table in which the α values output from the second counter are associated individually with evenly dispersed values each smaller than the 10^{Y-X};

a conversion portion configured to convert the output from the second counter to values each smaller than the 10^{Y-X} by referring to the table; and

an addition portion configured to add up the output from the first counter and the output from the conversion portion so as to generate the timestamp in increments of the 10^{-Y} seconds. The reception apparatus includes:

a division portion configured to divide the timestamp in increments of the 10^{-Y} seconds transmitted by the transmission apparatus by 10^{Y-X} so as to obtain a quotient and a remainder;

a multiplication portion configured to multiply by α the quotient obtained by the division portion;

a reverse conversion portion configured to convert in reverse the remainder obtained by the division portion to values each smaller than the 10^{Y-X} in reference to the table to which the conversion portion of the transmission apparatus refers; and

an addition portion configured to add up the output from the multiplication portion and the output from the reverse conversion portion so as to restore the clock value based on the reference clock of the α×10^{X} Hz.

According to the preceding embodiment of the present disclosure, the transmission apparatus counts a clock value based on a reference clock of α×10^{X} Hz so as to output values in increments of 10^{Y-X} at intervals of α for α consecutive times. The clock value above is counted based on the reference clock so as to output α values 0 through α−1 repeatedly. In reference to a table in which the repeatedly output α values are associated individually with evenly dispersed values each smaller than 10^{Y-X}, the output α values are converted to values each smaller than 10^{Y-X}. And the values output in increments of 10^{Y-X} at intervals of α and the values resulting from the conversion are added up so as to generate the timestamp in increments of 10^{-Y} seconds.

Furthermore, the timestamp in increments of 10^{-Y} seconds is divided by 10^{Y-X} so as to obtain a quotient and a remainder. The quotient obtained above is multiplied by α. The remainder obtained above is converted in reverse to values each smaller than 10^{Y-X} in reference to the table to which the conversion portion of the transmission apparatus refers. Then, the output resulting from the multiplication and the output from the reverse conversion are added up so as to restore the clock value based on the reference clock of α×10^{X} Hz.

According to the present disclosure embodied as outlined above, it is possible to transmit a timestamp allowing the reference clock value to be restored without error.

Also, according to this disclosure embodied as outlined above, it is possible to communicate the timestamp between the master device and the slave device without error.

### BRIEF DESCRIPTION OF THE DRAWINGS

FIG. 1 is a schematic view outlining an ordinary high-precision time synchronization process that uses IEEE 1588 PTP;

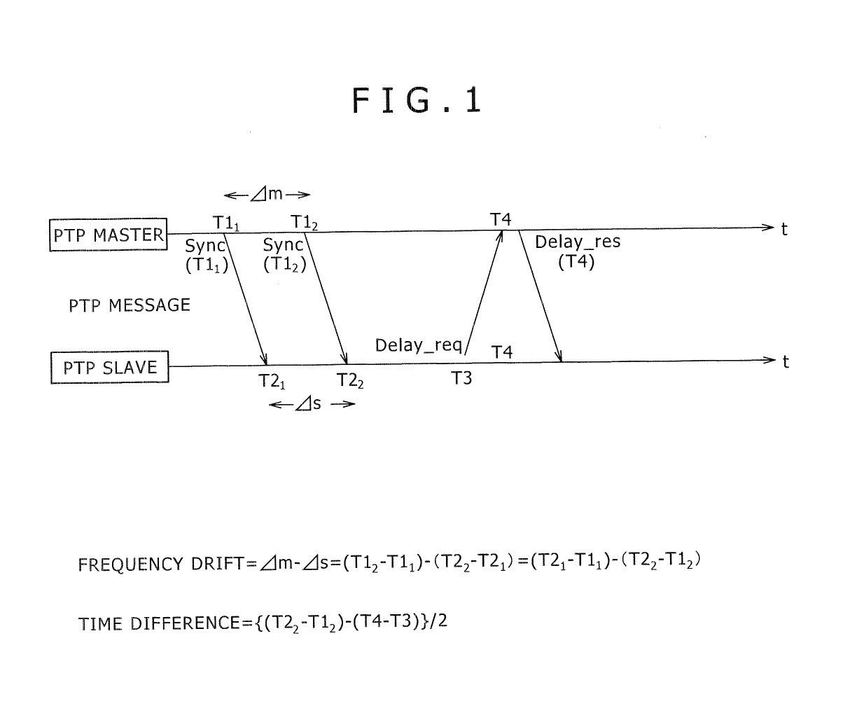

FIG. 2 is a block diagram showing a typical configuration of a communication system to which the present disclosure is applied and which includes a PTP master and a PTP slave;

FIG. 3 is a schematic view showing a typical structure of the functional blocks making up a nanosecond (ns) conversion processing part;

FIG. 4 is a circuit diagram corresponding to the structure in FIG. 3;

FIG. 5 is a tabular view showing a typical table in effect when the reference clock is α MHz;

FIG. 6 is a tabular view showing a typical table in effect when the reference clock is 27 MHz;

FIG. 7 is a flowchart explanatory of an ns conversion process;

FIG. 8 is a schematic view showing a typical structure of the functional blocks making up an ns reverse conversion processing part;

FIG. 9 is a flowchart explanatory of an ns reverse conversion process;

FIG. 10 is a tabular view listing the output from components of the ns conversion processing part in effect when the reference clock is a MHz;

FIG. 11 is a tabular view listing the output from components of the ns reverse conversion processing part in effect when the reference clock is α MHz;

FIG. 12 is a tabular view listing the output from components of the ns conversion processing part in effect when the reference clock is 27 MHz;

FIG. 13 is a tabular view listing the output from components of the ns reverse conversion processing part in effect when the reference clock is 27 MHz; and

FIG. 14 is a block diagram showing a typical structure of a computer.

### DETAILED DESCRIPTION OF THE PREFERRED EMBODIMENT

The best mode for carrying out the present disclosure (called the embodiment hereunder) is described below in detail by reference to the accompanying drawings.

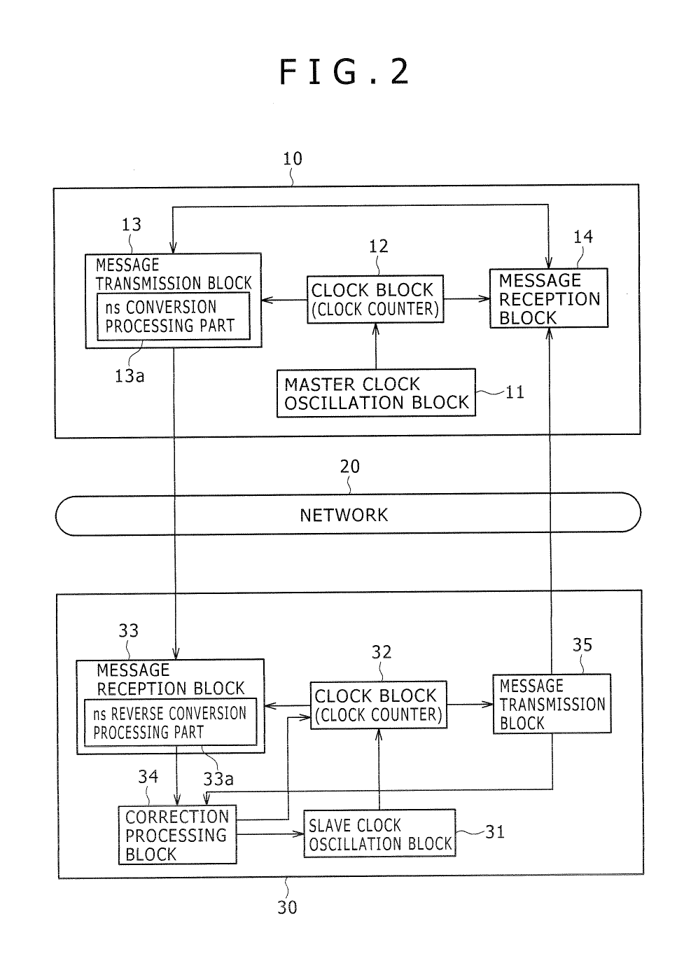

FIG. 2 shows a communication system embodying the present disclosure, the system being made of a PTP master 10 and a PTP slave 30 interconnected via a network 20. It should be noted that FIG. 2 indicates only those structures of the PTP master and PTP slave that are related to frequency synchronization and time synchronization therebetween.

The PTP slave 30 of this system exchanges PTP messages with the PTP master 10 via the network 20. In doing this, the PTP slave 30 synchronizes its time information with that of the PTP master 10.

The PTP master 10 includes a master clock oscillation block 11, a clock block 12, a message transmission block 13, and a message reception block 14.

The master clock oscillation block 11 generates a reference clock of a frequency f1=α MHz and outputs the generated reference clock to the clock block 12. Although the frequency f1 for this embodiment is assumed to be 27 MHz (i.e., α=27), the value α is not limited to 27. The present disclosure is particularly effective where the division of 1000/α gives a remainder.

The clock block 12 counts up an internal counter in accordance with the reference clock of the frequency f1, and supplies the message transmission block 13 and message reception block 14 with the clock value thus counted as the time information of the PTP master 10.

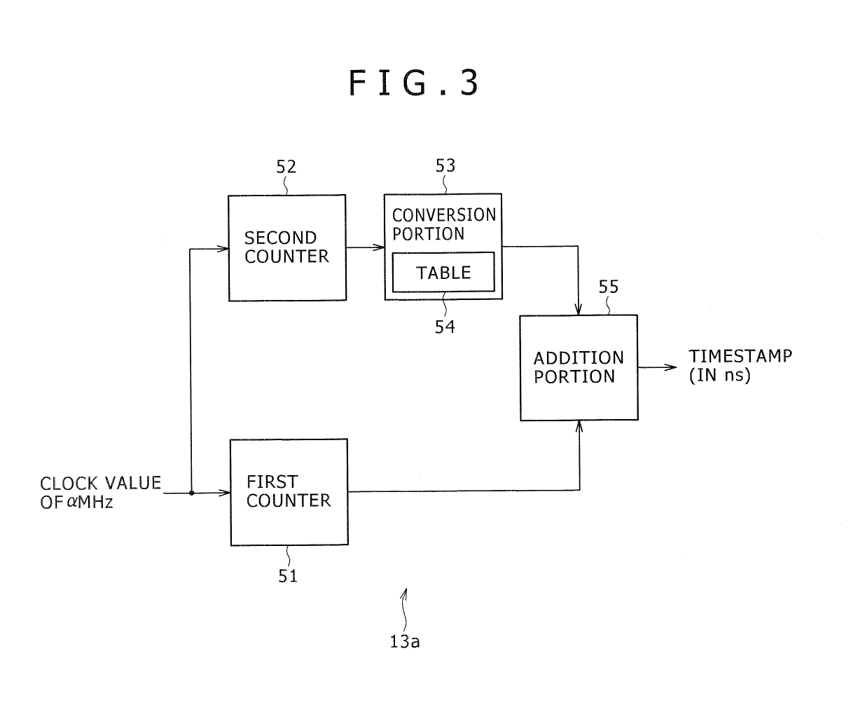

The message transmission block 13 includes an ns conversion processing part 13a that converts the time information (clock value of f1=α MHz) to a timestamp in nanoseconds. The ns conversion processing part 13a will be discussed later in detail by reference to FIG. 3.

Upon transmitting a Sync message, the message transmission block 13 converts the time information (clock value of α MHz) representing a transmission time T1ᵢ in effect at the time to a timestamp in nanoseconds. The message transmission block 13 transmits onto the network 20 the Sync message including the transmission time T1ᵢ represented by the timestamp in nanoseconds in a predetermined cycle Δm. Also, when the message reception block 14 receives a message “Delay_req” from the PTP slave 30, the message transmission block 13 converts to a timestamp in nanoseconds the time information (clock value of α MHz) representing a reception time T4 communicated from the message reception block 14. The message transmission block 13 returns a PTP message “Delay_res” including the reception time T4 represented by the timestamp in nanoseconds to the PTP slave 30 via the network 20.

When receiving the message “Delay_req” from the PTP slave 30, the message reception block 14 notifies the message transmission block 13 of the time information (clock value of α MHz) representing the reception time T4 in effect at the time.

Meanwhile, the PTP slave 30 includes a slave clock oscillation block 31, a clock block 32, a message reception block 33, a correction processing block 34, and a message transmission block 35.

The slave clock oscillation block 31 generates a reference clock of a frequency f2 and outputs the generated reference clock to the clock block 32. Also, the slave clock oscillation block 31 adjusts the frequency f2 in such a manner that a frequency drift Δm−Δs input from the correction processing block 34 and indicated by the expression (1) above will become zero.

The clock block 32 counts up an internal counter in accordance with the reference clock of the frequency f2, and supplies the message reception block 33 and message transmission block 35 with the count value as the clock value representing the time information of the PTP slave 30. Also, the clock block 32 adjusts the time information (clock value of the frequency f2) in such a manner that the time difference input from the correction processing block 34 and indicated by the expression (4) above will become zero.

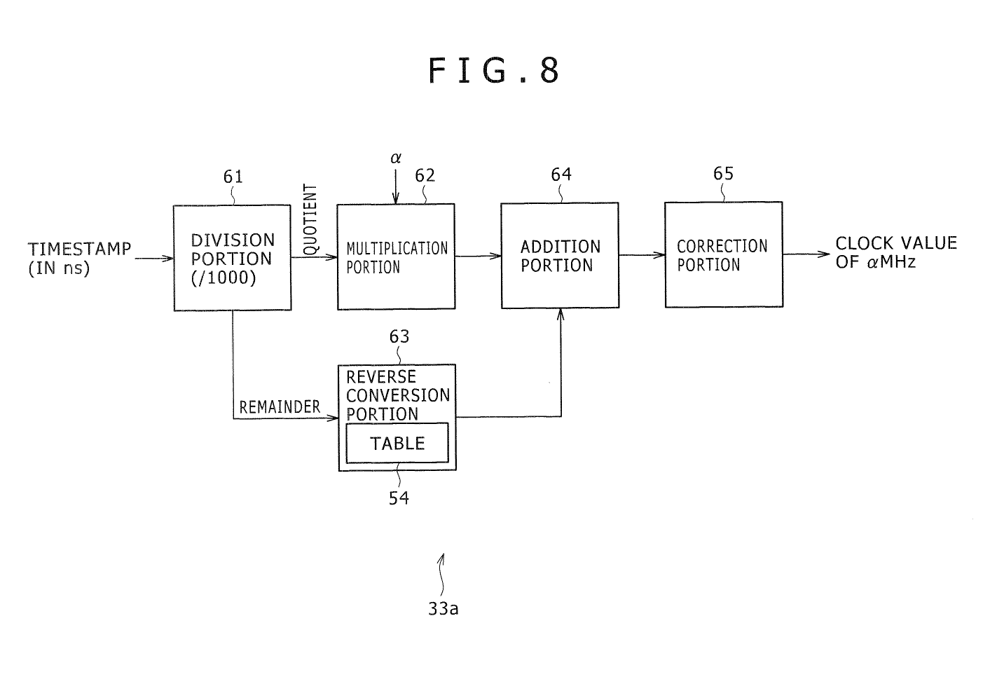

The message reception block 33 incorporates an ns reverse conversion processing part 33a that converts in reverse the timestamp in nanoseconds to time information (clock value of α MHz). The ns reverse conversion processing part 33a will be discussed later in detail by reference to FIG. 8.

The message reception block 33 receives the Sync message transmitted as a PTP message from the PTP master 10 via the network 20, and extracts from the Sync message the transmission time T1ᵢ represented by the timestamp in nanoseconds. Also, the message reception block 33 converts in reverse the transmission time T1ᵢ represented by the timestamp in nanoseconds to the clock value of α MHz and outputs the clock value to the correction processing block 34. Furthermore, the message reception block 33 outputs the reception time T2 (clock value of the reference f2) in effect upon receipt of the Sync message to the correction processing block 34.

Also, with the message “Delay_req” transmitted by the PTP slave 30, the message reception block 33 receives a PTP message “Delay_res” returned from the PTP master 10 via the network 20. The message reception block 33 extracts from the received message “Delay_res” the reception time T4 represented by the timestamp in nanoseconds of the message “Delay_req.” Furthermore, the message reception block 33 converts in reverse the reception time T4 represented by the timestamp in nanoseconds to the clock value of α MHz, and outputs the clock value to the correction processing block 34.

Based on the transmission time T1 (clock value of a MHz) input from the message reception block 33 and on the reception time T2 (clock value of α MHz) in effect at the time, the correction processing block 34 calculates the frequency drift Δm−Δs indicated by the expression (1) above and outputs the result of the calculation to the slave clock oscillation block 31.

Furthermore, based on the transmission and reception times T1 and T2 (clock values of α MHz) of the Sync message, on the transmission time T3 (clock value of the frequency f2) of the message “Delay_req” input from the message transmission block 35, and on the reception time T4 (clock value of α MHz) of the message “Delay_req,” the correction processing block 34 calculates the time difference indicated by the expression (4) above and outputs the calculated time difference to the clock block 32.

The message transmission block 35 transmits the message “Delay_req” to the PTP master 10 via the network 20, and outputs the transmission time T3 (clock value of the frequency f2) in effect at the time to the correction processing block 34.

### [Typical Structure of the ns Conversion Processing Part 13a]

FIG. 3 shows a typical structure of the functional blocks making up the ns conversion processing part 13a included in the message transmission block 13 of the PTP master 10.

The ns conversion processing part 13a is made up of a first counter 51, a second counter 52, a conversion portion 53, and an addition portion 55.

The first counter 51 outputs the one thousands' and higher digits of a timestamp in nanoseconds. The first counter 51 outputs an increment of 1000 for α consecutive times. That is, when the time information (clock value of α MHz) input from the clock block 12 is from 0 to α−1, the first counter 51 outputs zero; when the time information is from α to 2α−1, the first counter 51 outputs 1000; when the time information is from 2α to 3α−1, the first counter 51 outputs 2000, and so on. When the output of the first counter 51 reaches 10⁹−10³ and the value is output for a consecutive times, the first counter 51 resets the output to zero. Exactly at this moment, a second-counting counter (not shown) is incremented to count up an accurate one second.

The second counter 52 determines the hundreds' and lower digits of the timestamp in nanoseconds. When the time information (clock value of α MHz) input from the clock block 12 is from α to α−1, the second counter 52 outputs the same value as the input; when the input is from α to 2α−1, the second counter 52 outputs values 0 through α−1 consecutively. Thereafter, the second counter 52 likewise outputs values 0 through α−1 in a row in keeping with the input. That is, the second counter 52 serves as a ring counter outputting values 0 through α−1 consecutively.

By referring to an internal table 54, the conversion portion 53 outputs the one hundreds' and lower digits of the timestamp in nanoseconds corresponding to the value of the second counter.

The addition portion 55 adds up the one thousands' and higher digits of the timestamp in nanoseconds input from the first counter 51, and the one hundreds' and lower digits of the timestamp in nanoseconds input from the conversion portion 53, so as to generate a timestamp in nanoseconds of less than one second.

Although not shown in FIG. 3, the timestamp in increments of one second is assumed to be output when the output of the first counter 51 is 10⁹−10³ and when the output of the second counter 52 is α−1.

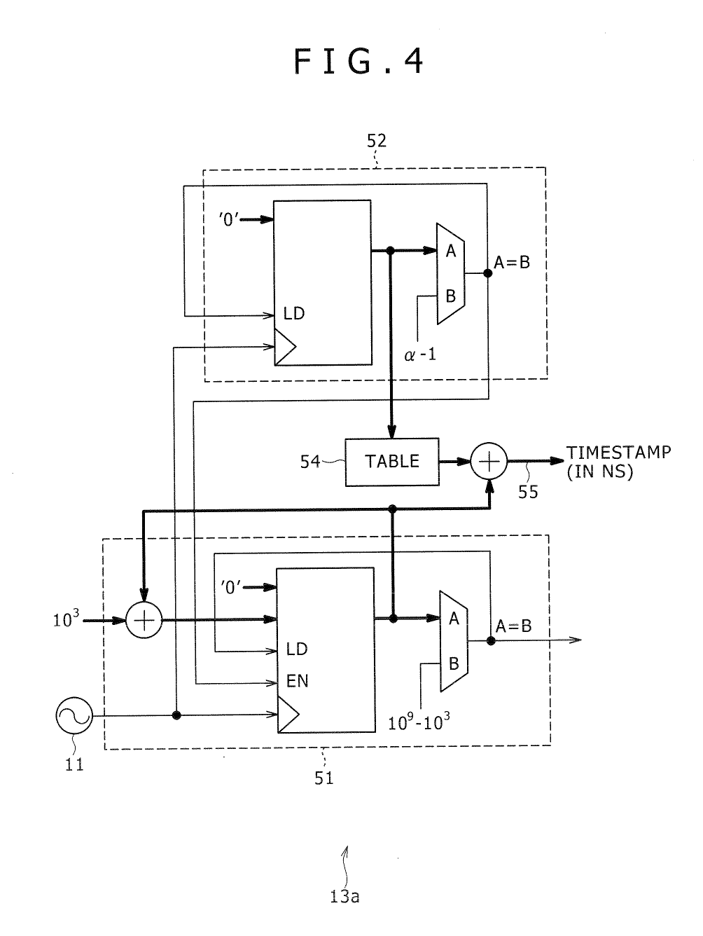

FIG. 4 shows a typical structure of an electrical circuit embodying the structure of the functional blocks constituting the ns conversion processing block 13a shown in FIG. 3. In FIG. 4, the components corresponding to the functional blocks in FIG. 3 are given the same reference numerals, and their explanations are omitted hereunder where redundant.

### [Examples of the Table]

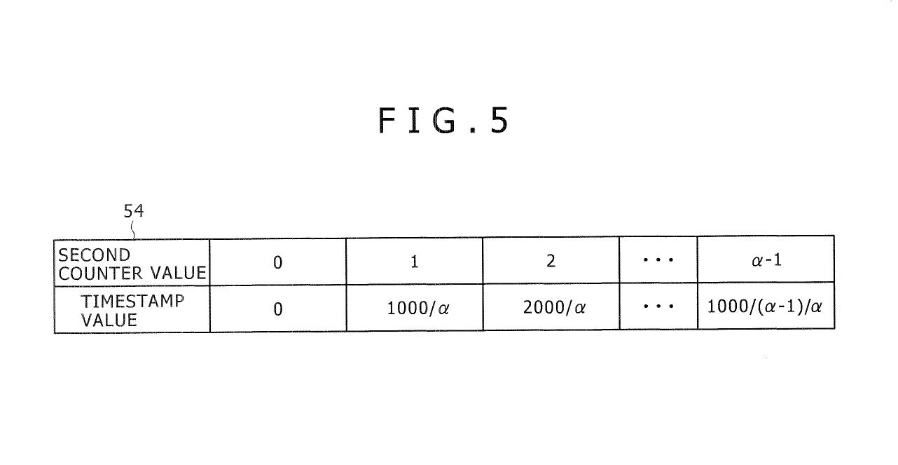

FIG. 5 shows a typical table 54 in effect when the master clock oscillation block 11 of the PTP master 10 generates the reference clock of α MHz, the table 54 being included in the conversion portion 53.

In the table 54, as many as α values 0 through α−1 from the second counter are recorded in association with evenly dispersed timestamp values in nanoseconds of the one hundreds' and lower digits.

For example, the value 0 from the second counter is associated with a timestamp value t₀=0; the value 1 from the second counter is associated with a timestamp value t₁=1000/α (integer); and the value 2 from the second counter is associated with a timestamp value t₂=2×1000/α (integer).

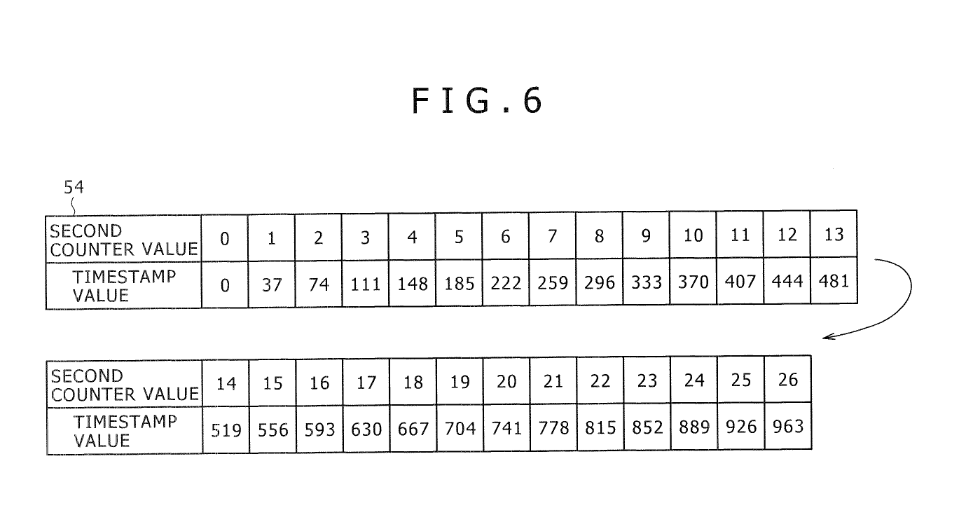

FIG. 6 shows another typical table 54 in effect when the master clock oscillation block 11 of the PTP master 10 generates the reference clock of 27 MHz (i.e., α is 27).

In this case, the table 54 has 27 values 0 through 26 from the second counter recorded in association with evenly normalized timestamp values in nanoseconds of the one hundreds' and lower digits. For example, the value 1 from the second counter is associated with a timestamp value 37 in nanoseconds; the value 2 from the second counter is associated with a timestamp value 74 in nanoseconds; and the value 26 from the second counter is associated with a timestamp value 963 in nanoseconds.

### [Explanation of the ns Conversion Processing Part 13a in Operation]

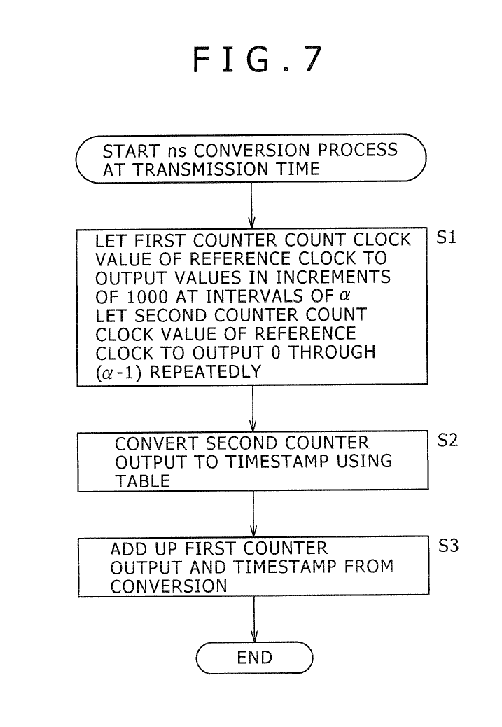

Explained below is an ns conversion process carried out by the PTP master 10 when transmitting a timestamp to the PTP slave 30. FIG. 7 is a flowchart explanatory of the ns conversion process.

In step S1, the first counter 51 counts the time information (clock value of α MHz) input from the clock block 12 to output values in increments of 1000 for α consecutive times to the addition portion 55, e.g., outputting 0 when the input information is from 0 to α−1, 1000 from α to 2α−1, and 2000 from 2α to 3α−1.

Simultaneously, the second counter 52 counts the time information (clock value of α MHz) input from the clock block 12 to output to the conversion portion 53 the same value as the input when the input is from 0 to α−1; 0 to α−1 consecutively when the input is from a to 2α−1; and likewise 0 to α−1 consecutively in keeping with the input thereafter.

In step S2, the conversion portion 53 outputs the one hundreds' and lower digits of a timestamp in nanoseconds corresponding to the value of the second counter by referring to the internal table 54.

In step S3, the addition portion 55 adds up the one thousands' and higher digits of the timestamp in nanoseconds input from the first counter 51, and the one hundreds' and lower digits of the timestamp in nanoseconds input from the conversion portion 53, so as to generate a timestamp in nanoseconds of less than one second.

The timestamp in nanoseconds converted from the clock value of α MHz as described above is then transmitted to the PTP slave 30.

### [Typical Structure of the ns Reverse Conversion Processing Part 33a]

FIG. 8 shows a typical structure of the functional blocks making up the ns reverse conversion processing part 33a included in the message reception block 33 of the PTP slave 30.

The ns reverse conversion processing part 33a is made up of a division portion 61, a multiplication portion 62, a reverse conversion portion 63, an addition portion 64, and a correction portion 65.

The division portion 61 divides by 1000 the timestamp in nanoseconds included in the Sync message or message “Delay_res” transmitted from the PTP master 10, to obtain the quotient (integer) and a remainder (a value of the one hundreds' and lower digits). The division portion 61 outputs the quotient to the multiplication portion 62 and the remainder to the reverse conversion portion 63.

The multiplication portion 62 multiplies by α (27 for this embodiment) the quotient input from the division portion 61, and outputs the result of the multiplication to the addition portion 64. The reverse conversion portion 63 incorporates the same table 54 as that included in the conversion portion 53 of the ns conversion processing part 13a. By referring to the table 54, the reverse conversion portion 63 converts the remainder (the one hundreds' and lower digits of the timestamp in nanoseconds) input from the division portion 61 to a clock value of α MHz, and outputs the obtained clock value to the addition portion 64.

The addition portion 64 adds up the output from the multiplication portion 63 and the output from the reverse conversion portion 63 to restore the clock value of α MHz and outputs the restored clock value to the correction portion 65. It should be noted that the clock value of α MHz restored by the addition portion 64 is delayed by the time required for the ns reverse conversion processing part 33a to perform its processing. Thus the correction portion 65 corrects the clock value of α MHz by adding a predetermined value corresponding to the delay time incurred by the ns reverse conversion processing part 33a to the output from the addition portion 64, and outputs the corrected clock value to the subsequent stage.

### [Explanation of the ns Reverse Conversion Processing Part 33a in Operation]

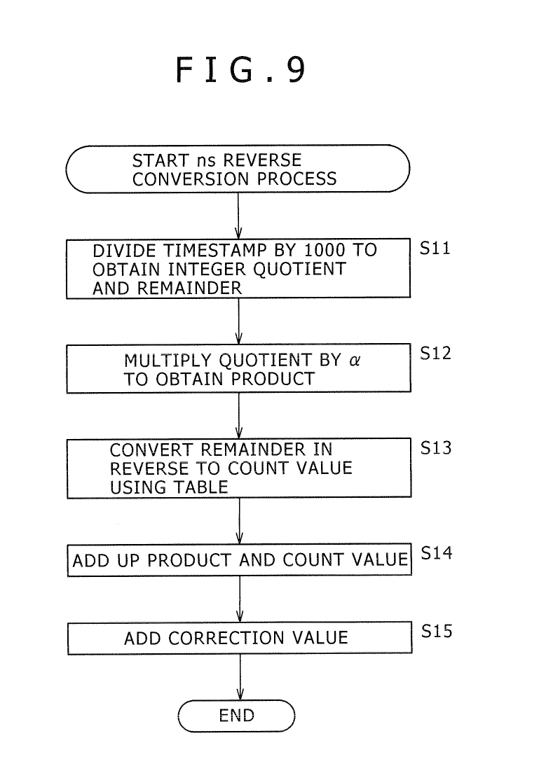

Explained below is an ns reverse conversion process performed by the PTP slave 30 upon receipt of the Sync message or the message “Delay_res” including a timestamp in nanoseconds from the PTP master 10. FIG. 9 is a flowchart explanatory of the ns reverse conversion process.

In step S11, the division portion 61 divides by 1000 the timestamp in nanoseconds included in the Sync message or the message “Delay_res” transmitted from the PTP master 10, to obtain the quotient (integer) and a remainder (a value of the hundred's and lower digits). The division portion 61 outputs the quotient to the multiplication portion 62 and the remainder to the reverse conversion portion 63.

In step S12, the multiplication portion 62 multiplies by α the quotient input from the division portion 61, and outputs the result of the multiplication to the addition portion 64. In step S13, the reverse conversion portion 63 converts the remainder input from the division portion 61 to the clock value of α MHz by referring to the table 54, and outputs the obtained clock value to the addition portion 64.

In step S14, the addition portion 64 adds up the output from the multiplication portion 62 and the output from the reverse conversion portion 63 to restore the clock value of α MHz, and outputs the restored clock value to the correction portion 65. In step S15, the correction portion 65 corrects the clock value of α MHz by adding a predetermined value corresponding to the delay time incurred by the ns reverse conversion processing part 33a to the output from the addition portion 64, and outputs the corrected clock value to the subsequent stage.

In the manner described above, the timestamp in nanoseconds transmitted from the PTP master 10 is converted in reverse to the clock value of α MHz. This makes it possible for the PTP slave 30 to operate in synchronism with the PTP master 10 on the basis of the reference clock of α MHz.

### [Explanation of Examples of Conversion]

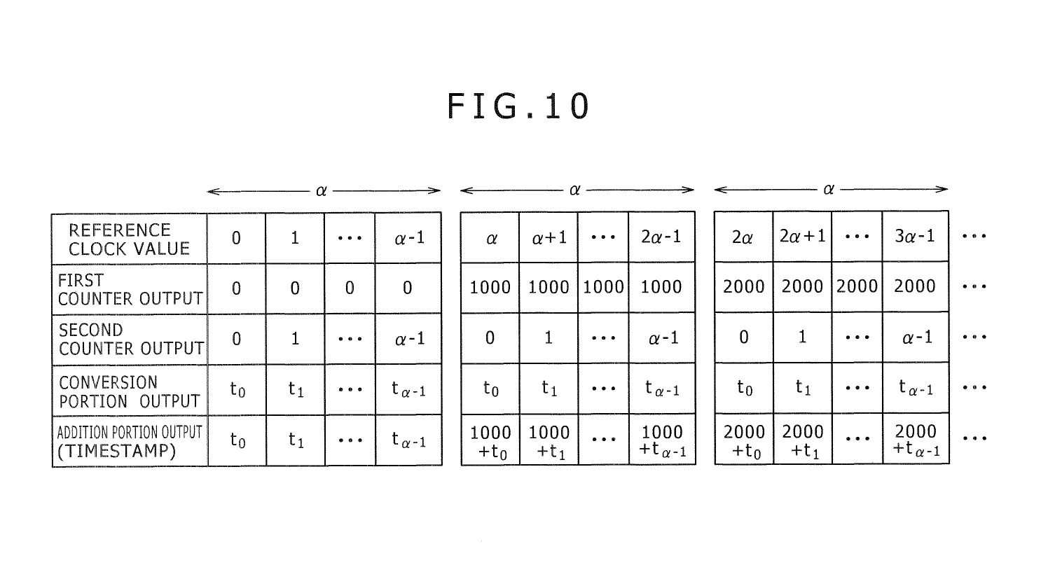

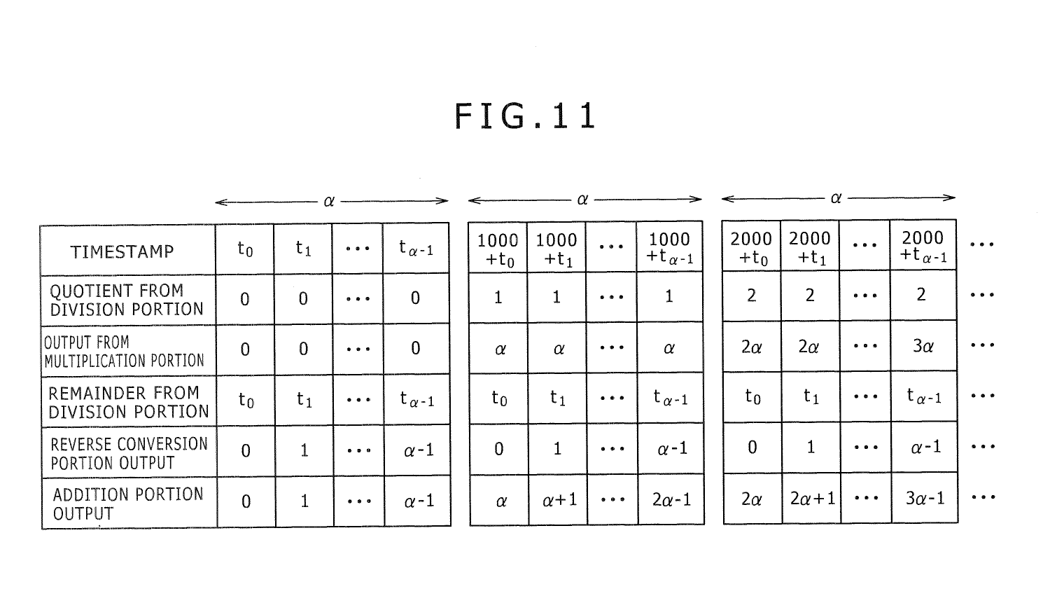

FIG. 10 lists the output from components of the ns conversion processing part 13a in effect when the reference clock is α MHz. FIG. 11 lists the output from components of the ns reverse conversion processing part 33a corresponding to the output shown in FIG. 10.

As is evident from the comparison between the clock values of the reference clock shown in the uppermost part of FIG. 10 and the output from the addition portion 64 indicated in the lowermost part of FIG. 11, it can be verified that the clock value of α MHz transmitted from the PTP master 10 is accurately restored by the PTP slave 30.

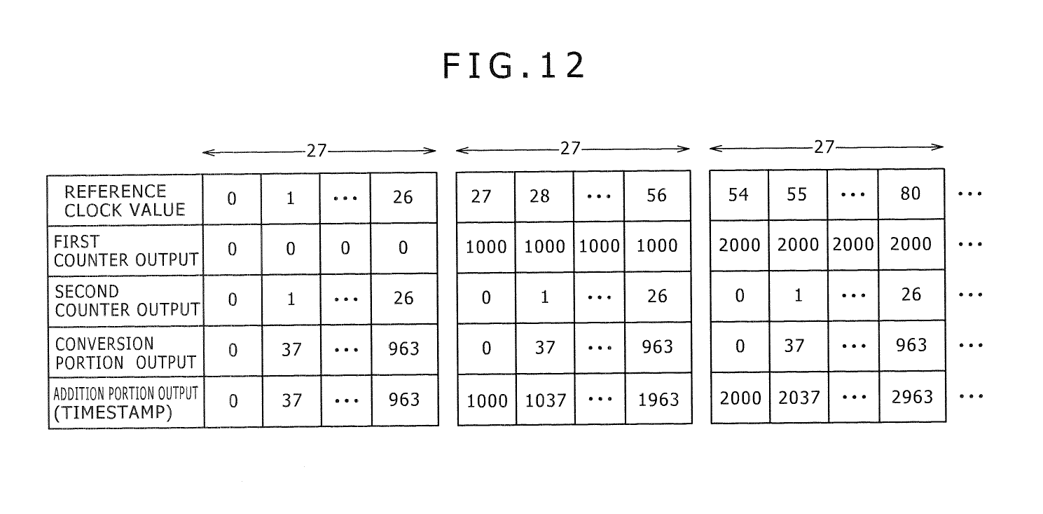

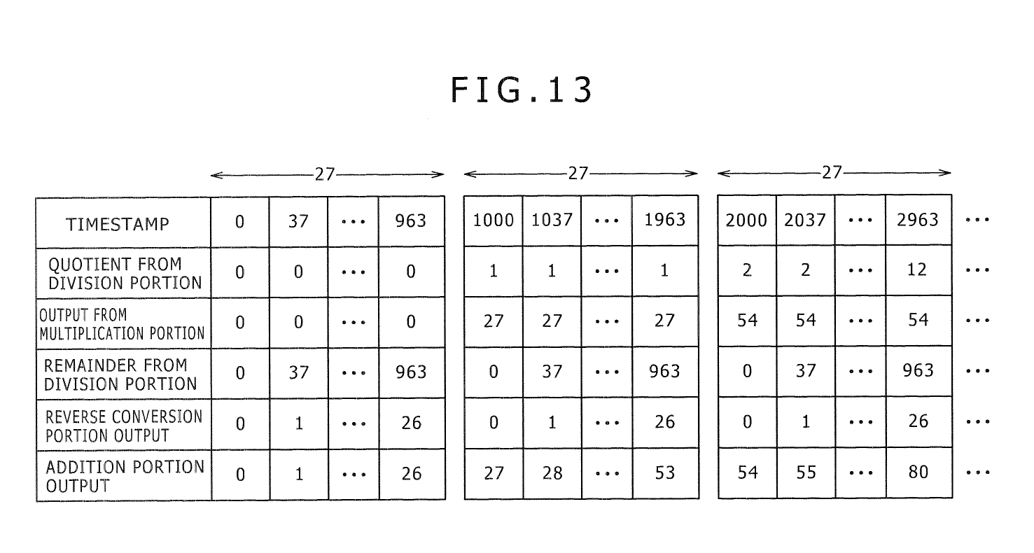

FIG. 12 lists the output from components of the ns conversion processing part 13a in effect when the reference clock is 27 MHz. FIG. 13 lists the output from components of the ns reverse conversion processing part 33a corresponding to the output shown in FIG. 12.

As is also evident from the comparison between the clock values of the reference clock shown in the uppermost part of FIG. 12 and the output from the addition portion 64 indicated in the lowermost part of FIG. 13, it can be ascertained that the clock value of 27 MHz transmitted from the PTP master 10 is accurately restored by the PTP slave 30.

According to the present disclosure explained above, it is possible, without recourse to complicated calculations, to convert the clock value of α MHz to the timestamp in nanoseconds which in turn is accurately converted in reverse to the clock value of α MHz. Thus the PTP save 30 is protected from developing malfunction due to the accumulated error in the restored clock value of α MHz.

The above embodiment was explained on the assumption that α MHz of the reference clock is 27 MHz. Alternatively, this disclosure can also be applied to cases where α MHz is 33 MHz or some other suitable frequency. In such cases, however, the table 54 above needs to retain the indicated correspondence with the 33 values.

For the embodiment above, the order of the timestamp was shown to be in nanoseconds. Alternatively, the order of the timestamp may be determined otherwise.

The series of the above-described processes performed by the ns conversion processing part 13a or by the ns reverse conversion processing part 33a may be executed either by hardware or by software. Where the processes are to be carried out by software, the programs constituting the software are installed into a suitable computer for execution. Such computers may include those with the software incorporated in their dedicated hardware beforehand, and those such as general-purpose personal computers or the like capable of executing diverse functions based on various programs installed therein.

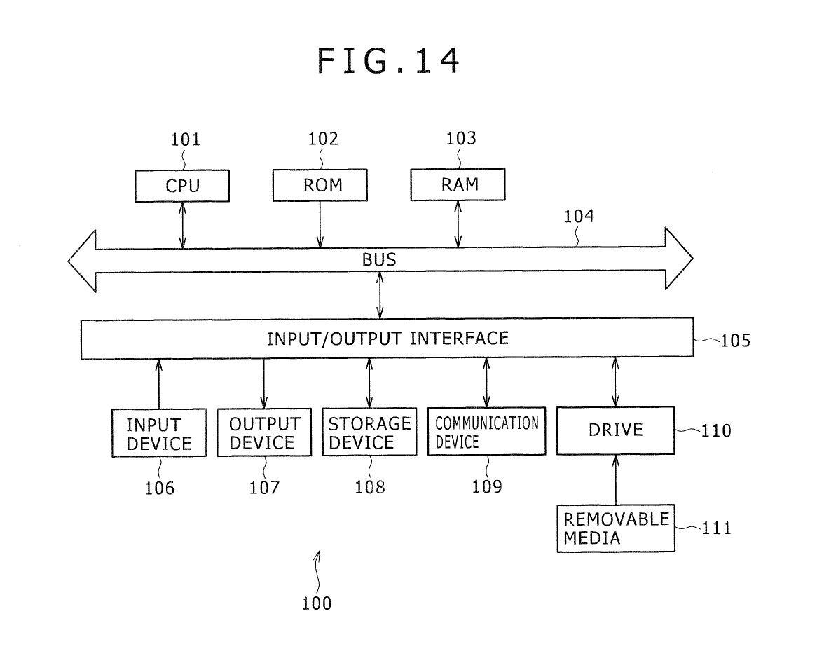

FIG. 14 is a block diagram showing a typical structure of a computer that executes the series of the above-described processes using programs.

In this computer, a CPU (central processing unit) 101, a ROM (read only memory) 102, and a RAM (random access memory) 103 are interconnected via a bus 104.

The bus 104 is further connected with an input/output interface 105. The input/output interface 105 is connected with an input device 106, an output device 107, a storage device 108, a communication device 109, and a drive 110.

The input device 106 is usually made of a keyboard, a mouse, and a microphone. The output device 107 is generally composed of a display and speakers. The storage device 108 is ordinarily formed by a hard disk or a nonvolatile memory. The communication device 109 is constituted by a network interface or the like. The drive 110 drives removable media 111 such as magnetic disks, optical disks, magneto-optical disks, or semiconductor memories.

In the computer structured as outlined above, the CPU 101 performs the series of the above-described processes by loading relevant programs from, say, the storage device 108 into the RAM 103 via the input/output interface 105 and bus 104 and by executing the loaded programs.

The programs executed by the computer (i.e., CPU 101) may be offered recorded on the removable media 111 constituting package media or the like, for example. The programs may also be offered through wired or wireless communication media such as local area networks, the Internet, or digital satellite broadcasts.

When a suitable piece of the removable media 111 carrying the relevant programs is attached to the drive 110, the programs are installed from the medium into the storage device 108 through the input/output interface 105. Alternatively, the programs may be received by the communication device 109 through wired or wireless transmission media before getting installed into the storage device 108. As another alternative, the programs may be preinstalled in the ROM 102 or in the storage device 108.

Also, the programs to be executed by the computer may be processed in the depicted sequence of this specification (i.e., on a time series basis), in parallel, or in otherwise appropriate timing such as when they are invoked as needed.

It should be understood by those skilled in the art that various modifications, combinations, sub-combinations and alterations may occur depending on design requirements and other factors in so far as they are within the scope of the appended claims or the equivalents thereof.

The present disclosure contains subject matter related to that disclosed in Japanese Priority Patent Application JP 2012-034652 filed in the Japan Patent Office on Feb. 21, 2012 the entire content of which is hereby incorporated by reference.

What is claimed is:

1. A transmission apparatus for transmitting a timestamp in increments of 10^{-Y} seconds in accordance with a standard, the transmission apparatus comprising:
a first counter configured to count a clock value based on a reference clock of α×10^{X} Hz so as to output values in increments of 10^{Y-X} at intervals of α for α consecutive times;
a second counter configured to count the clock value based on the reference clock so as to output α values 0 through α−1 repeatedly;
a table in which the α values output from the second counter are associated individually with evenly dispersed values each smaller than the 10^{Y-X};
a conversion portion configured to convert the output from the second counter to values each smaller than the 10^{Y-X} by referring to the table, and
an addition portion configured to add up the output from the first counter and the output from the conversion portion so as to generate the timestamp in increments of the 10^{-Y} seconds.

2. The transmission apparatus according to claim 1, wherein
the standard is IEEE 1588 PTP, and
the increments of 10^{-Y} are increments of 10⁻⁹.

3. The transmission apparatus according to claim 2, wherein
the α×10^{X} Hz is 27×10⁶ Hz.

4. The transmission apparatus according to claim 2, further comprising:
a clock block configured to generate the clock value by counting up in accordance with the reference clock of the α×10^{X} Hz.

5. A transmission method for use with a transmission apparatus for transmitting a timestamp in increments of 10^{-Y} seconds in accordance with a standard, the transmission method comprising:
counting a clock value based on a reference clock of α×10^{X} Hz so as to output values in increments of 10^{Y-X} at intervals of α for α consecutive times;
counting the clock value based on the reference clock so as to output α values 0 through α−1 repeatedly;
in reference to a table in which the repeatedly output α values are associated individually with evenly dispersed values each smaller than the 10^{Y-X}, converting the output α values to values each smaller than the 10^{Y-X}, and
adding up the values output in increments of 10^{Y-X} at intervals of α and the values resulting from the conversion so as to generate the timestamp in increments of the 10^{-Y} seconds.

6. A program for use with a computer for transmitting a timestamp in increments of 10^{-Y} seconds in accordance with a standard, the program causing the computer to function as an apparatus comprising:
a first counter configured to count a clock value based on a reference clock of α×10^{X} Hz so as to output values in increments of 10^{Y-X} at intervals of α for α consecutive times;
a second counter configured to count the clock value based on the reference clock so as to output values 0 through α−1 repeatedly;
a table in which the α values output from the second counter are associated individually with evenly dispersed values each smaller than the 10^{Y-X};
a conversion portion configured to convert the output from the second counter to values each smaller than the 10^{Y-X} by referring to the table, and
an addition portion configured to add up the output from the first counter and the output from the conversion portion so as to generate the timestamp in increments of the 10^{-Y} seconds.

7. A communication system comprising:
a transmission apparatus configured to communicate with a reception apparatus a timestamp in increments of 10^{-Y} seconds in accordance with a standard; and
the reception apparatus,
wherein the transmission apparatus includes
a first counter configured to count a clock value based on a reference clock of α×10^{X} Hz so as to output values in increments of 10^{Y-X} at intervals of α for α consecutive times,
a second counter configured to count the clock value based on the reference clock so as to output α values 0 through α−1 repeatedly,
a table in which the α values output from the second counter are associated individually with evenly dispersed values each smaller than the 10^{Y-X},
a conversion portion configured to convert the output from the second counter to values each smaller than the 10^{Y-X} by referring to the table, and
an addition portion configured to add up the output from the first counter and the output from the conversion portion so as to generate the timestamp in increments of the 10^{-Y} seconds, and
the reception apparatus includes
a division portion configured to divide the timestamp in increments of the 10^{-Y} seconds transmitted by the transmission apparatus by 10^{Y-X} so as to obtain a quotient and a remainder,
a multiplication portion configured to multiply by α the quotient obtained by the division portion,
a reverse conversion portion configured to convert in reverse the remainder obtained by the division portion to values each smaller than the 10^{Y-X} in reference to the table to which the conversion portion of the transmission apparatus refers, and
an addition portion configured to add up the output from the multiplication portion and the output from the reverse conversion portion so as to restore the clock value based on the reference clock of the α×10^{X} Hz.
